(19) United States
(12) Patent Application Publication
(10) Pub. No.: US 2020/0058010 A1
(43) Pub. Date: Feb. 20, 2020

(54) MANAGING PRE-ACCOUNTING, ACCOUNTING AND E-TRADE SYSTEMS FROM A SINGLE PANEL

(71) Applicant: Safak OKTEM, Istanbul (TR)

(72) Inventor: Safak OKTEM, Istanbul (TR)

(21) Appl. No.: 16/345,770

(22) PCT Filed: Oct. 27, 2017
(86) PCT No.: PCT/TR2017/050527

§ 371 Date: Apr. 29, 2019

(30) Foreign Application Priority Data
Oct. 27, 2016 (TR) 2016/15343

(51) Int. Cl. G06Q 20/20; G06Q 50/12; G06Q 10/08; G06Q 40/00; G06Q 30/04

(52) U.S. Cl. CPC G06Q 20/203; G06Q 50/12; G06Q 20/202; G06Q 40/123; G06Q 40/125; G06Q 20/204; G06Q 30/04; G06Q 10/087

(57) ABSTRACT

Systems that can provide financial recording, pre-accounting and accounting requirements of companies, with which accounting declarations can be prepared and notified to the state, and on which an e-commerce website can be uploaded and used for sales.

### CROSS REFERENCE TO THE RELATED APPLICATIONS

This application is the national phase entry of International Application No. PCT/TR2017/050527, filed on Oct. 27, 2017, which is based upon and claims priority to Turkish Patent Application No. 2016/15343, filed on Oct. 27, 2016, the entire contents of which are incorporated herein by reference.

### TECHNICAL FIELD

The invention subject to the application is related to systems that can provide the financial recording, pre-accounting and accounting requirements of companies, with which accounting declarations can be prepared and notified to the state, and on which an e-commerce website can be uploaded and used for sales.

### BACKGROUND

The known systems can communicate with each other by means of software tools. In present systems pre-accounting, accounting and e-commerce systems are purchased/hired from different companies and if necessary data transfer can be carried out between software programs manually or by using integration software if necessary and as a result information is upgraded.

The patent document numbered US20160104252 A1 of the known state of the art does not describe an Inventory System. Another disadvantage of this known state of the art invention is that if an inventory card that is deleted in the pre-accounting records, this is not relayed to the e-commerce module, and therefore the item will be continued to be sold and when then sales is carried out the order will not be submitted to pre-accounting.

Another disadvantage of this known state of the art invention is that when a stock sales is carried out or a product is sold via a cash register, information is not submitted to the e-commerce module immediately, and therefore the product sales is continued in the e-commerce website and during this time if sales is carried out via the e-commerce website, the inventory stock quantity will be negative. Moreover e-commerce and accounting modules have not been mentioned in this patent document.

The patent document numbered US20140122264A1 of the known state of the art, describes a system which links credit cards and debit cards (customer card) with each other following payments carried out via POS devices. If transferring to the accounting program is supported following payments received by means of cash registers the transfer is carried out and if it is not supported integration cannot be performed.

When the present applications known in the state of the art is taken into consideration, it is observed that an application which can manage pre-accounting, accounting and e-commerce systems from a single panel is not present.

### SUMMARY

The present invention is related to managing pre-accounting, accounting and e-commerce systems from a single panel in order to provide new advantages to the related technical field and to eliminate the disadvantages mentioned above.

The aim of the invention it to be able to eliminate technical problems that may arise due to double recording and wrong recording by means of using a single panel in an integrated system, to reduce manpower, provide support and price advantages by using an integrated system and providing error free recording and reducing financial costs.

Another aim of the invention is to provide a system that enables to prepare and/or send the declarations via an accounting module, that need to be submitted legally without the need to re-enter the valuable paperwork of the accounting department into a new system.

Another aim of the invention is to minimize the information transfer problems, to prevent the need to record the same records several times to the e-commerce, pre-accounting and accounting systems separately and therefore to provide a system which is reliable, enables easy usage and entering of correct data.

A preferred embodiment of the invention comprises an integrated interface and system, a modular structure, and system modules that comprise hardware that can be accessed via a user interface or via a main system.

Another preferred aim of the invention is to provide a system having a shopping basket and payment system which informs the main system that there is a problem regarding transfer if the order cannot be transferred following any kind of optional purchase trial.

Another preferred embodiment of the invention is that the system comprises an offline check system related to the Restaurant Module check system (order system).

According to yet another preferred embodiment of the invention the system enables reciprocal processing of the cash register pos device.

According to yet another preferred embodiment of the invention the system the integration of the cash register pos device, is configured such that it can operate offline in the case that connection is lost between the middleware and the main system.

According to yet another preferred embodiment of the invention the Restaurant Online Reservation module is configured such that the information which determines if a table is free for reservation or not, can be modified by the administrator.

According to yet another preferred embodiment of the invention the online reservation of the restaurant module, is configured such that it can be used as a scripted theme, or as a customized module whose design can be changed directly by changing the JavaScript codes and by changing the style such as html, css etc.

According to yet another preferred embodiment of the invention the Restaurant Online Reservation module is configured such that a mobile application can be integrated to the system.

According to yet another preferred embodiment of the invention the Restaurant Online Reservation module is configured such that it comprises a module interface which allows the customer to place a food order.

According to yet another preferred embodiment of the invention the Restaurant Online Reservation module is configured such that the inventory list tables can be accessed via both the module database and the shared table scheme of the company's data base by being able to order an additional menu.

According to yet another preferred embodiment of the invention the Restaurant Online Reservation module is configured such that the ordering hours during the day can be determined by the administrator.

According to another preferred embodiment of the invention the system is configured such that it enables to scan an OCR invoice, receipt, check or bill via the OCR receipt recognition module via an image file from the web interface or the camera of a mobile device via a mobile application.

According to another preferred embodiment of the invention the system has an OCR that performs OCR receipt recognition, and scanning and definition of OCR invoices, financial receipts and bills and has functions such as determining the total receipt amounts, the receipt rows, date, time, receipt number, with an algorithm and an OCR algorithm that facilitates recording of the receipt information that is desired to be transferred to the system.

According to a preferred embodiment of the invention the system is an OCR invoice and financial receipt and bill scanning and recognition tool which performs OCR receipt recognition and it comprises an OCR having document scanning features comprising the process steps of, the system detects the shift ratio, in the case that the total of the invoice is printed a little beneath or above the total amount due to shifting of the rows to another row in invoices, the system has four different recognition algorithm values, the first being distinguishing the fonts of the texts that have been written in the original invoice and the fonts of the values that have been printed with an invoice printer, the second being calculating the coordinates of the scanned sections on the document, third being determining a table, if the scanned document has separation lines that separates the rows, or in other words if the document is printed as a table, wherein a template recognition method is used which helps to recognize and determine the contents of the lines by analyzing the written values in the first header column at the left side of the table or the header columns and/or rows in the first line, and the fourth being finding the values by detecting the headers that have been pre-defined in the system.

According to a preferred embodiment of the invention the system comprises the steps of following the scanning process of the OCR invoice whose OCR receipt recording has been carried out and the scanning of the financial receipt and check and bills that that have the defined fields in the scanned document are transferred to the new record form fields, and if a value is scanned incorrectly, the user is able to correct this mistake and the document is recorded into the main system together with the image of the document after confirmation.

According to a preferred embodiment of the invention the shared table scheme structures are configured such that reference confusion between two databases is eliminated.

According to another preferred embodiment of the invention the system comprises an accounting and taxation system which enables to prepare in the system and to submit from the system, VAT, VAT2, VAT list to be uploaded, VAT list to be downloaded, withholding tax return, form ba (statement of purchasing goods and services) and form bs (statement of sales of goods and services), annual income statements, provisional tax returns (income), corporation tax, provisional tax returns (corporation), sales invoices, and customs export declaration lists domestically and other documents that need to be submitted to the state or abroad.

According to another preferred embodiment of the invention the system of managing accounting and e-commerce from a single panel comprises an accounting and taxation system which enables to submit via this system all kinds of statements and declarations, if the tax office in the related country supports said system.

According to another preferred embodiment of the invention, the system comprises an accounting and taxation system which enables to obtain accounts chart, trial balance, operating ledger, operating accounts summary and other various reports via the system.

According to another preferred embodiment of the invention, the system comprises an accounting and taxation system which enables the system to either automatically or manually record receipts during the accounting process of pre-accounting receipts.

According to another preferred embodiment of the invention, the system comprises an accounting and taxation system that enables to create either manually or automatically the accounting codes for cards such as stocks, current accounts, bank and cash accounts.

According to another preferred embodiment of the invention, the system comprises an accounting and taxation system which enables to obtain accounts chart, trial balance, operating ledger, operating accounts summary and other various reports via the system.

According to another preferred embodiment of the invention, the system comprises hardware that can be directly accessed by the main system using a user interface that provides communication with the invoice printer via the IP address, internet scanner, mobile application or desktop application, with a receipt printer via the internet Explorer, mobile application or desktop application, with a barcode reader and cash register having a barcode reader via the internet Explorer, mobile application, mobile camera, or desktop application, with a middleware that operates on a computer via a network that is connected to the cash register by an Ethernet card, via the internet IP address, or with a cash register pos device that has a middleware that operation on a computer that is directly connected to the cash register.

According to another preferred embodiment of the invention the system comprises a modular structure operating on a web server, having its own controller ( ), an HTML web interface ( ) for users and optional mobile applications.

According to another preferred embodiment of the invention the system comprises a modular structure which updates itself via remote commands and update controls.

According to another preferred embodiment of the invention the system comprises a modular structure comprising mobile applications which directly communicate with the module service through the module.

According to another preferred embodiment of the invention the system comprises a modular structure having mobile applications which communicate with the main system.

According to another preferred embodiment of the invention the system comprises a modular structure comprising a module controller that enables to perform payment procedures for an order given through the module.

According to another preferred embodiment of the invention the system comprises a modular structure that uses web services in order to access the modules in the main system.

According to another preferred embodiment of the invention the system comprises a modular structure that allows the company to have a plurality of modules.

According to another preferred embodiment of the invention the system comprises an integrated interface and system which serves to control all modules, integrations and crucial data connected to the system.

### BRIEF DESCRIPTION OF THE DRAWINGS

The figures that have been prepared in order to further illustrate the system which enables to manage pre-accounting, accounting and e-commerce systems from a single panel are described below.

FIG. 1, is the schematic view showing the definition of the system modules and their relation to each other.

FIG. 2, shows the general view of the module system.

FIG. 2.1—shows the dynamic module system.

FIG. 3, shows the module user interfaces.

FIG. 4—shows the inventory (stock) integration system.

FIG. 5, shows the e-commerce module product stock query system.

FIG. 6, shows the shopping cart and payment system.

FIG. 7, shows the examples of adding new orders to the system.

FIG. 8, shows the connection to the tax system.

FIG. 9, is the shared table schemes.

FIG. 10, is the scanning and recognition of OCR invoice, financial receipt, checks and bills.

FIG. 11, is the Restaurant module online reservation.

FIG. 12, is the Restaurant module online ordering system.

FIG. 13, is the payment systems.

FIG. 14, is the cash register-pos device integration.

FIG. 15 is the hotel reservation system.

### DETAILED DESCRIPTION OF THE EMBODIMENTS

In the detailed description the novelty invention is described by means of examples that do not limit the invention but are intended to further describe the invention. Accordingly the operation of managing pre-accounting, accounting and e-commerce systems from a single panel, its aspects and aims have been described in detail below.

The communication between the e-commerce and pre-accounting modules are saved with the same identification information in different databases using reciprocal and shared tables and the database records are updated in the shared table schemes by taking the company database as basis. In the case that an error occurs when entering a record the record that is entered via transaction is deleted and the error is notified to the user.

Another aim of the invention is to minimize the information transfer problems, to prevent the need to record the same records several times to the e-commerce, pre-accounting and accounting systems separately and therefore to provide a system which is reliable, enables easy usage and entering of correct data.

Another aim of the invention is to provide a system that enables to prepare and/or send the declarations via an accounting module, that need to be submitted legally without the need to re-enter the valuable paperwork of the accounting department into a new system. (The notification of declarations to the tax offices differ from country to country).

The problems solved by the system are as follows:
As the main system module database can be directly reached, the procedures carried out at the accounting department can be directly recorded into the database of the module,
By this means, the problem of linking the common values used such as the mistakenly deleted or changed variant definitions, unit definitions, vat rates, current cards or stock cards are eliminated,
As the shared table schemes in the system are updated both in the database of the company and the module database, the rate of errors are reduced to 0,
The shared table schemes and stock cards eliminate the need to carry out separate characterization on both the accounting and the other modules,
As all processes can be carried out on a single panel rather than managing two different systems, disorganization is minimized and manageability is increased,
The price is more advantageous,
As support is received from a single company rather than two different companies, the costs and technical problems are easily determined,
The legal statements that need to be submitted to the tax offices are formed by the system,

The integrated interface and system, modular structure, user interface and/or hardware that can be directly accessed by the system, and the system modules formed from the accounting and tax system is characterized in that it is formed of module user interfaces, inventory (stock) integration system, e-commerce module product inventory query system, shopping cart and payment system, examples of adding orders to the main system, restaurant module online reservation, restaurant module bill (checkorder) system, payment systems, cash register pos device integration, hotel reservation system, connection to the tax system, scanning and recognition of OCR invoices, financial receipts, checks and bills, and shared table scheme structures.

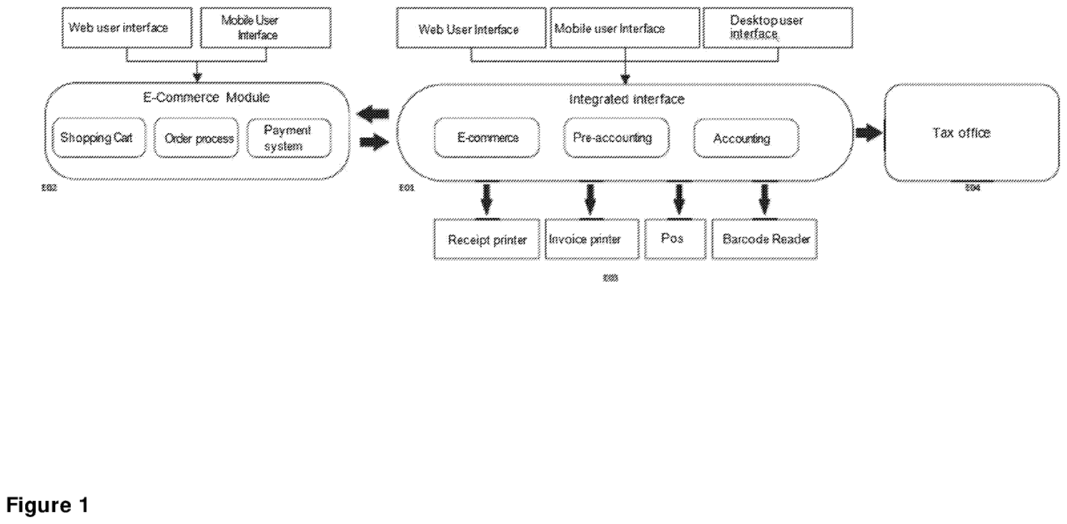

The schematic view showing the definition of the system modules and their relation to each other has been referred to in FIG. 1.

E01: The integrated (combined) interface and system: This system serves to control all modules, integrations and crucial data connected to the system. The transactions between the user and the service is carried out by the Html web interface, mobile applications and desktop applications. The pre-accounting and accounting procedures are directly recorded here.

As it can be seen from FIG. 1, the E01 is related to the Integrated interface and system and E02, E03 and E04 are related to the web user interface, mobile user interface and desktop user interface.

The main system can have direct access to the database of the modules. The main system operates such that the module and the shared tables are updated synchronously. If the module or the database of the module that operates on a separate server cannot be reached at a certain period of time, the processes that have been made shall be retrieved and the consistency of the main system and module is maximized.

The main system not only can have direct connection to the database of the modules, but it also can establish reliable authorization and connection with the web service and the module controller.

If the pre-accounting, accounting and module panels are desired to be managed or are managed from a single panel, the authorization and user accesses can be limited.

E02: E-commerce module-Modular structure: In FIG. 1, the shopping cart inside the module, the order processing and the payment system are located under the title “main headers”. A web user interface and a mobile user interface are also provided that are related with this module. Each module has its own controller, an HTML web interface for users and optional mobile applications.

The modules can be updated automatically or they can be updated by remote commands.

The mobile applications can communicate directly with the main system or via the module service.

The payment procedures for an order given through the module are carried out via the module controller.

The modules can provide access via the web services that have been customized for the module in the main system.

The modules do not have access to the databases in the main system.

A company can have more than one module. For example two e-commerce systems can be connected to one company or an e-commerce system+a restaurant system can be connected to one company.

E03: Hardware that can be accessed via the user interface or directly by the main system. This hardware can be a receipt printer, invoice printer, pos and barcode reader as shown in FIG. 1.
Communication is provided with the invoice printer via the IP address, internet explorer, mobile application or desktop application, with a receipt printer via the internet Explorer, mobile application or desktop application, with a barcode reader via a cash register having a barcode reader, the internet Explorer, mobile application, mobile camera, or desktop application, cash register pos device via the internet IP address, middleware operating on a computer located on a network connected to the cash register with an ethernet card or with a middleware that operates on a computer that is directly connected to the cash register.
E04: Accounting and taxation system. In FIG. 1, the E04 has been shown under the title of tax office.

According to another preferred embodiment of the invention the system enables to prepare in the system and to submit from the system, VAT, VAT2, VAT list to be uploaded, VAT list to be downloaded, withholding tax return, form ba (statement of purchasing goods and services) and form bs (statement of sales of goods and services), annual income statements, provisional tax returns (income), corporation tax, provisional tax returns (corporation), sales invoices, and customs export declaration lists domestically and other documents that need to be submitted to the state.

Moreover reports such as chart of accounts, a trial balance, an operating ledger and statement of accounts can be obtained via the main system.

The chart of accounts that are to be used in the recording of pre-accounting receipts can either be established automatically or manually according to the preference of the user. The accounting codes of the cards such as stocks, current accounts, and bank and cash accounts are formed automatically by the system in automatic accounting.

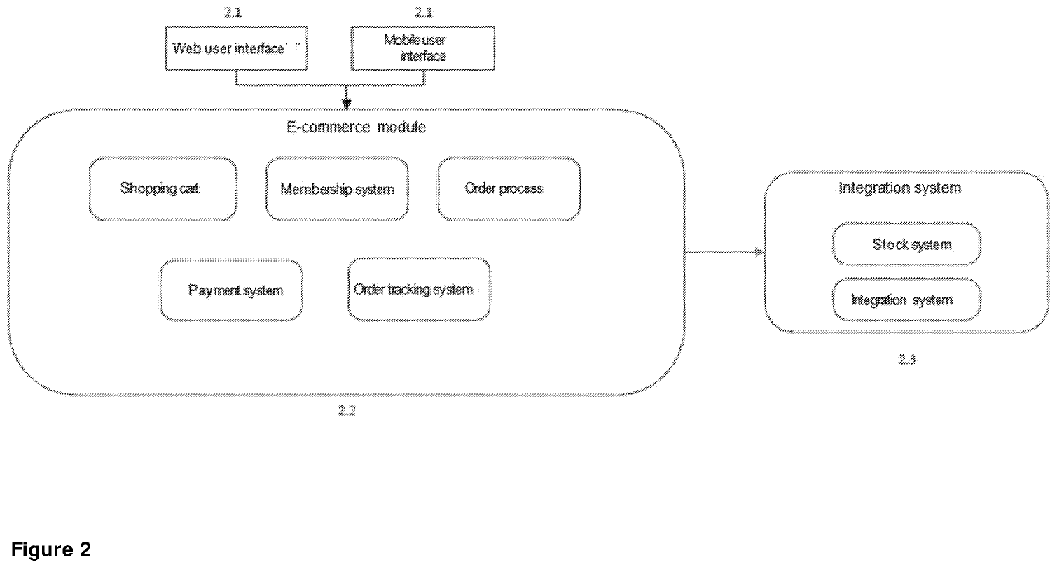

FIG. 2, shows the general view of the module system. The e-commerce module has been shown as an example. As the communication with the main system and updating logic of the modules are the same, only one example has been given.

2.1: The web interfaces can be used as a scripted theme, or as a customized module whose design can be changed directly by changing the JavaScript codes and by changing the style such as html, css etc.
A mobile application via a mobile user interface can be optionally added to the system for the module.
2.2: The shopping cart, membership system, order process, payment system, order tracking and integration system have been shown in FIG. 2, such that they have been linked to the e-commerce module. Each module controller has its own working principle, methods and software codes. The databases that are used by the modules can be specific or they can use a shared database template. The updating of each module is carried out automatically or manually. The modules can be updated automatically. In order for the modules to be able to be used, the required frameworks must be installed in the server that is to be used. The status of the server and the modules that are being used can be obtained by means of software and the initial installation files and upgrades can be obtained from the server. These processes can also be automatic and therefore time is saved.
2.3: Communication system between the module and the main system This system is an integration system wherein it has been shown in FIG. 2 under the title stock system and integration system.

The dynamic module system has been shown in FIG. 2. Dynamic module system;

The main module controller enables the sub module controls, installation and updates of modules. The module software codes have a dynamic structure. The module codes can be dynamically updated. These procedures are carried out with version control.

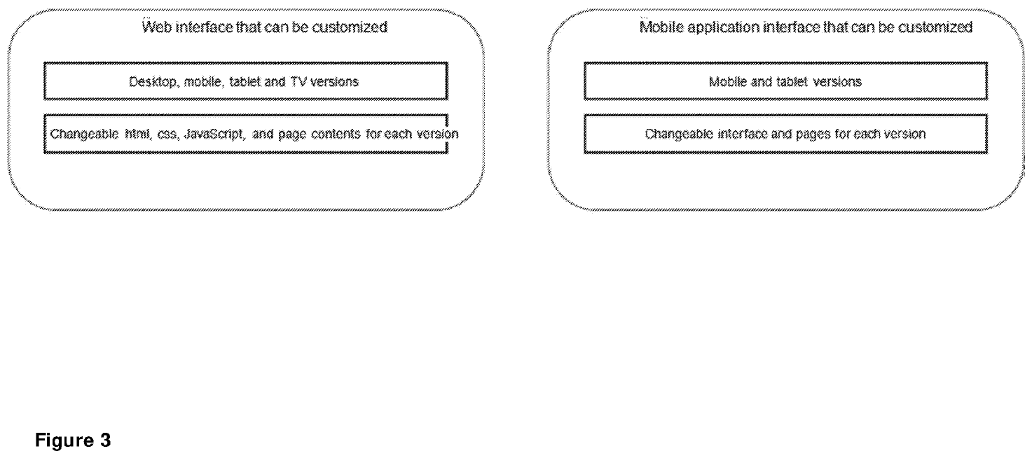

FIG. 3, shows the module user interfaces. The module user interfaces comprise the following;

The module interface options are: Web site, mobile web site and/or mobile application. Html Designs can be customized. The user can change the html codes, page contents, css or JavaScript codes from the user control panel according to his/her preferences. Desktop, mobile, tablet and TV versions can be provided with a customized web interface. Moreover it is also possible to customize the design of the mobile application connected to the module. The mobile application interface enables to customize the interface and the pages as mobile and tablet versions.

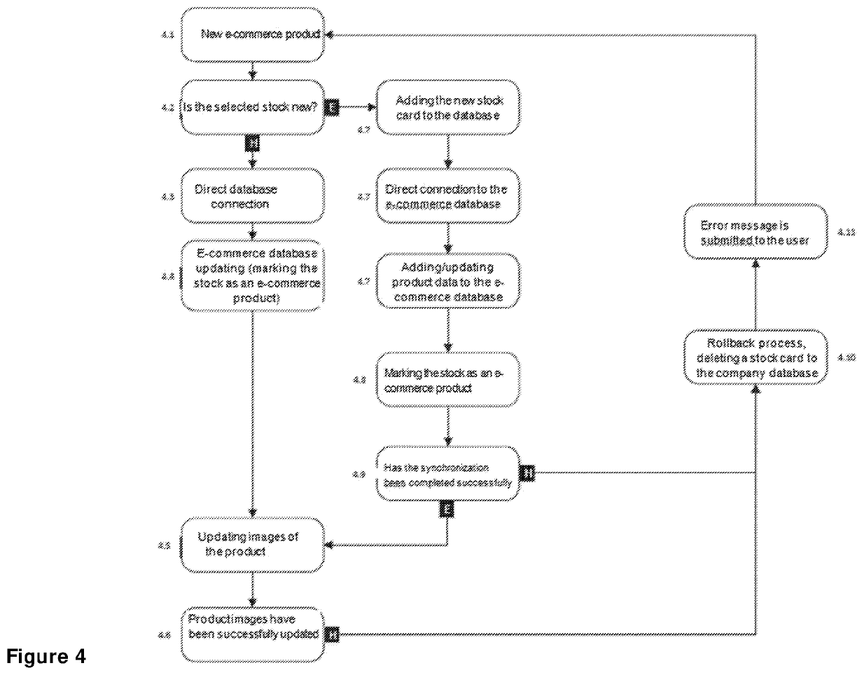

The inventory (stock) integration system is shown in FIG. 4, and it comprises the following process steps; The inventory (stock) integration system comprises the following process steps;
(4.1) The administrator adds a new product from the panel to the e-commerce system,
(4.2) The administrator is asked if he/she wants to use a new stock card or an old stock card that is already present,
(4.3) If a stock that is present is desired to be used the e-commerce database is accessed via the main system,
(4.4) the same stock card is matched from the e-commerce database of the main system and the product is defined and recorded as an e-commerce product in the registration section,
(4.5) The pictures of the product is sent by the controller of the e-commerce module,
(4.6) If the pictures of the product can be successfully uploaded, the process is completed and if an error occurs a (4.10) rollback process is applied,
(4.7) If a new stock card is desired to be added, a new record is created in the database of the company with the new stock information, The stock card that is created the stock card is added to the stock card table in the module database linked with the company in the shared structure with the same identification number,
(4.8) The related stock is marked as an e-commerce product in the database of the e-commerce module,
(4.9) If updating is completed, the process continues from step (4.5),
(4.10) If an error occurs the latest procedures that are carried out are recalled from both the database of the company and the e-commerce module,
(4.11) The user is notified of the error,
(4.12) The new product form is shown on the user panel for renewing the order such that the previously entered values still remain on the panel.

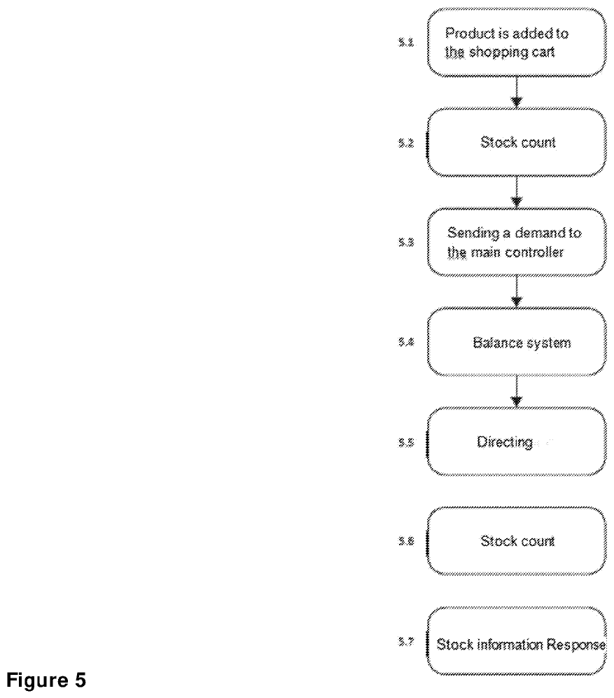

FIG. 5, shows the e-commerce module product stock query system. The e-commerce module product stock query system comprises the following process steps;
(5.1) The user adds a product to the shopping cart via the e-commerce module,
(5.2) A stock tracking mechanism is operated on the module controller,
(5.3) A demand is sent to the main system regarding stock information,
(5.4) The demand regarding stock information is sent from the main system to the balance system,
(5.5) The demand is sent to the suitable web service according to the demand queue,
(5.6) The web service directly connects to the database of the company and the information regarding the inventory and if the stock is suitable to be sold is checked,
(5.7) A response message is created and the process is returned to the module controller.

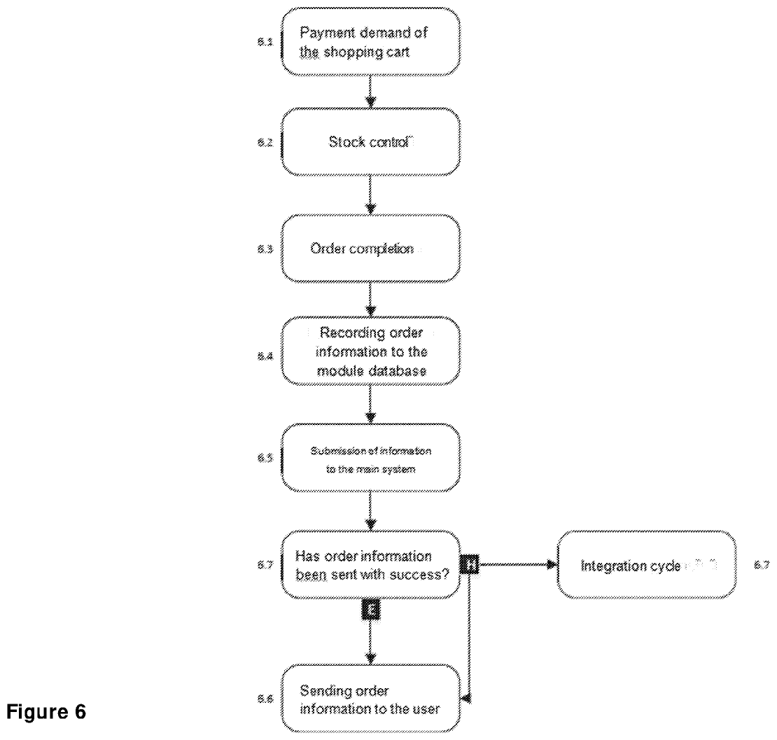

FIG. 6, shows the shopping cart and payment system. The shopping cart and payment system comprises the following steps;
(6.1) The user desires to purchase the products in the shopping cart,
(6.2) Stock check is carried out for each product (FIG. 5),
(6.3) The shopping process is completed by transferring payment (via applications such as paying at the door, bank wire, credit card, pay pal etc.),
(6.4) The shopping information is recorded in the database of the module by the module controller,
(6.5) The module controller submits the order information by operating synchronously (in the background) with the main system,
(6.6) The user is sent information regarding the completion of the order from any of the platforms that the user has been using,
(6.7) If the shopping information is not transferred to the main system the module controller shall try to transfer the order at a certain time cycle (at 2, 4, 8, 16, 32, 64 seconds),

If the order cannot be transferred after the 20th time, transfer error is submitted to both the e-commerce manager and the main system. (20 is an optional number that can be changed).

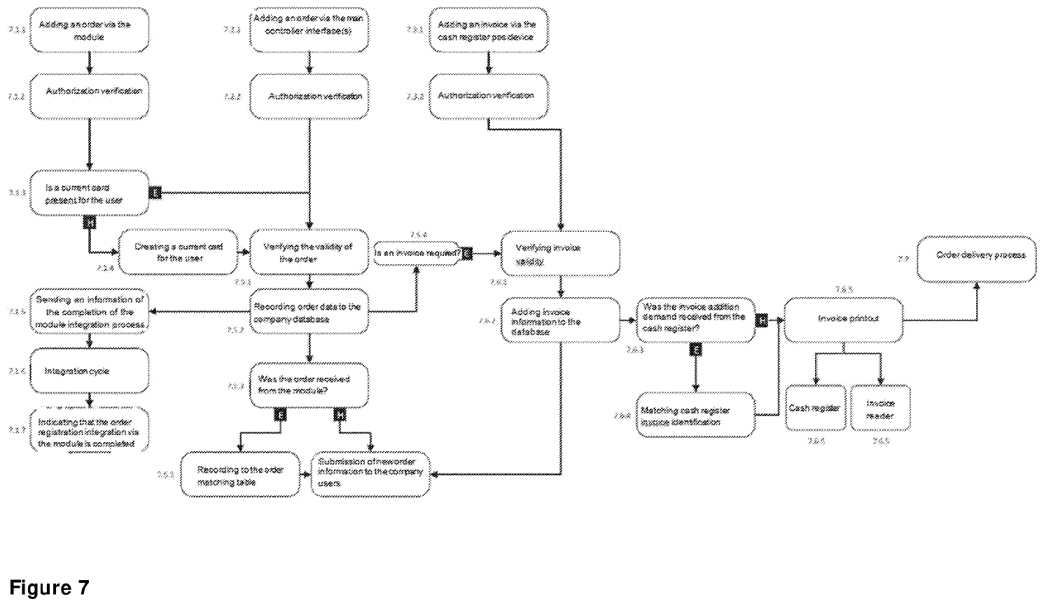

FIG. 7, shows the examples of adding new orders to the main system. The examples of adding new orders to the main system comprise the following process steps;
(7.1.1) An additional order is demanded from the module,
(7.1.2) The module authorizations are checked,
(7.1.3) It is checked if a current card that belongs to the member who has given the order is present or not in the database of the company,
(7.1.4) If a current card is not present the company is added to the database of the system, the integration information of the e-commerce system of the current customer shall be kept in a separate table,
(7.1.5) After the order transfer is completed a signal is submitted to the module,
(7.1.6) The cycle is completed if the e-commerce module is at the transfer cycle,
(7.1.7) The module database is marked as “order has been transferred”,
(7.5.1) The main system checks if the order is valid or not,
(7.5.2) If the invoice is valid it is added to the database of the company,
(7.5.3) If the order is received from the module, a module order matching record is kept together with the order added to a separate table in the company database,
(7.5.4) If an invoice wants to be created (the invoice can be created automatically according to the payment type, in the module settings) a new invoice demand is created with the added order identification information,
(7.6.1) The main system checks if the invoice is valid or not,
(7.6.2) If the invoice is valid it is added to the database of the company,
(7.6.2) It is checked if the invoice creation demand is made through the cash register,
(7.6.4) If the invoice is created through the cash register, the invoice that is added to the company database and the cash register identification information is matched,
(7.6.5) If an invoice is requested, it is automatically printed by the cash register or a printout is taken via the cash register, invoice printer or laser printer (printing an invoice by a laser printer may vary from country to country) manually,
(7.7) The order is prepared to be shipped,
(7.2.1) A new order is added through the main system module,
(7.2.2) The next step of checking user authorizations and order contents (7.5.1) is carried out,
(7.3.1) New invoice addition demand is made from the cash register,
(7.3.2) Cash register authorizations are checked and the step of checking the contents of the invoice (7.5.6) is carried out.

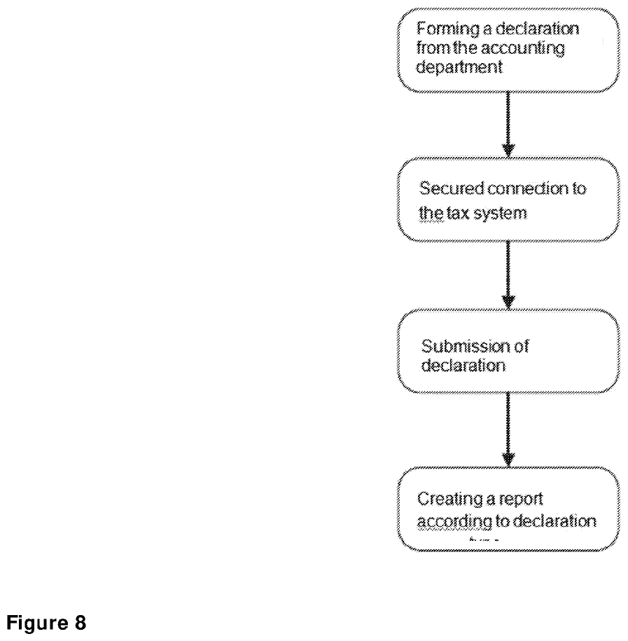

In FIG. 8, connection to the tax system is shown. Connection to the tax system; the submission of the e-declarations may vary according to the tax system of countries. If we take Turkey as an example, the main system can submit the declarations that have been established with a declaration user code, password and user name via the internet website of the online tax office. Other countries may have different contents in their declarations and the submission of the declarations may also vary. The operation method of the tax system is as follows;
Forming a declaration by the accounting department,
Providing reliable connection to the tax system,
Submitting the declaration,
Creating a report according to declaration type.

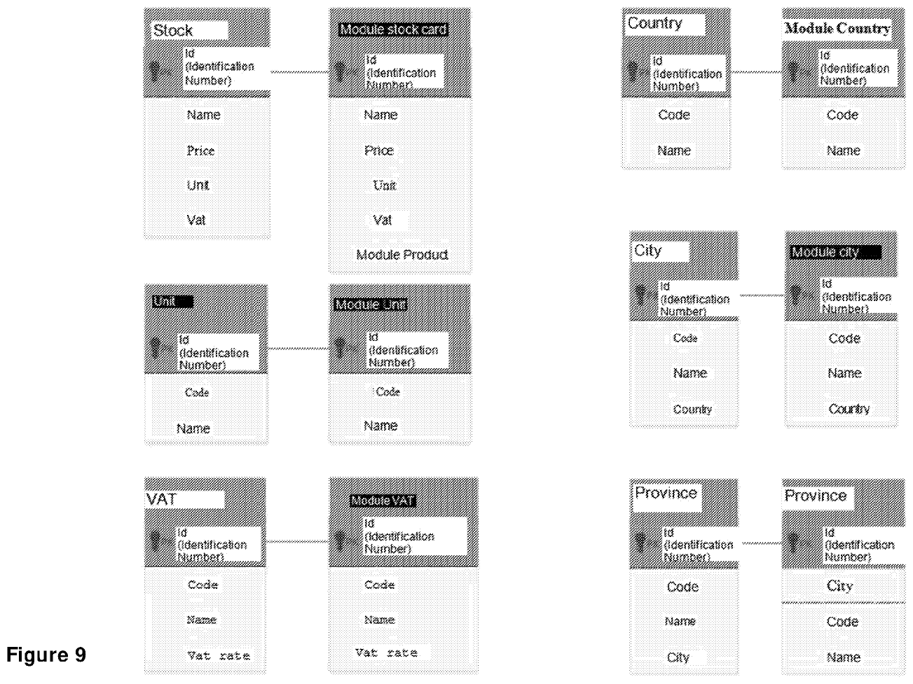

The tables that are used in a shared structure are shown in FIG. 9. Tables having a shared structure,
Tables having a shared table scheme: stock card, unit table, VAT table, variant table, country, city, province table etc.,
The tables that are used with a shared structure are located both in the company and the module database. Therefore the tables will not lead to reference confusion between two databases.
When a new record is added, an old record is edited or deleted in the company database on tables that are used in a shared structure, the same procedure is automatically carried out in the module database, and therefore preciseness is maximized.
Batch record updating or single record updating on databases using identification information can be performed.
In case the data cannot be saved in the update process in the module database, the processes carried out in the company database are retrieved and are reported as errors. This situation is a possibility that is below 0.0001% and technical support shall step in.
The number of the tables as a shared scheme can be changed according to the development or suitability of the system.
The system comprises tables that are used in a shared structure that can be modified which comprise inventory card, unit table, VAT table, variant table, Country, province, district etc. and sub contents such as ID number, code, name, country, vat rate, unit, module product etc.

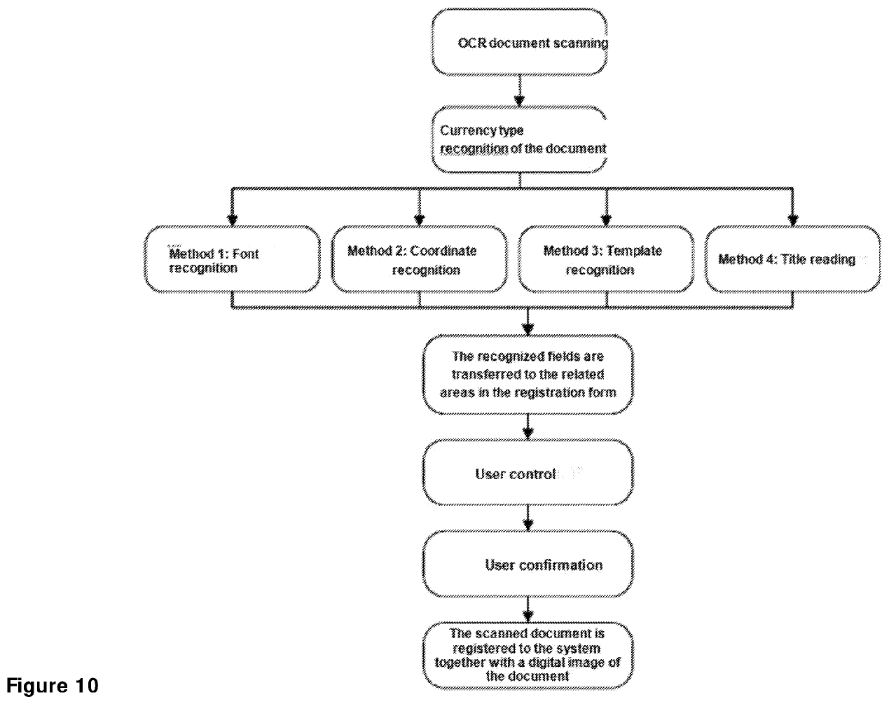

FIG. 10, shows the scanning and recognition of OCR invoice, financial receipt, checks and bills. The scanning and recognition of OCR invoice, financial receipt, checks and bills comprises the following steps;
OCR receipt recognition can be performed via an image file from the web interface or the camera of a mobile device via a mobile application. OCR has functions such as automatically finding current accounts from the total amounts of receipts, receipt rows, date, hour, receipt number and phone number information using our own algorithm and it also facilitates entering receipt information that is to be transferred to the system.
This module is still being improved and the defined receipt types shall be increased as the algorithms develop.
The total sum areas on the receipt can be recognized if a currency unit has been indicated. For example if 1000TL has been written on the total amount row on the invoice, the total amount and the abbreviation of TL is recognized by the system and the system will determine that the invoice currency is Turkish Lira.
Some rows may shift if the template is not correctly aligned in invoices. The total amount of the invoice may shift a little above or below the row. In such cases the system may be able to perceive the shift ratio and can scan all fields accordingly. Four types of definition algorithms have been provided. The first being distinguishing the fonts of the texts that have been written in the original invoice and the fonts of the values that have been printed with an invoice printer. The second being calculating the coordinates of the scanned sections on the document. This method is mostly related to cash register receipt print outs. As the receipt rows are listed one below the other, consistency is high. The third method is determining a table template. If the scanned document has separation lines that separates the rows, or in other words if the document is printed as a table, the system recognizes this table and the first header columns in the left section of the table and the header columns in the first row and/or the values written on the row shall be analyzed and the row contents are defined. The fourth method is that the predefined headers that have been predefined in the system are recognized and the values are determined. For example generally the date, invoice date and the invoice issue date for the date information in an invoice are indicated with headers. The next value following the header text also contains date information. (Date format may vary in formatting, for example: such as 10.10.2016, 10/10/2016, 10 Oct. 2016 etc). These four methods can be used during scanning of documents.
The fields that are defined in the document that has been scanned with an OCR are transferred to the new record form field. If a value has been scanned with a mistake, the user can change this and the document is recorded into the main system together with the image file of the document.

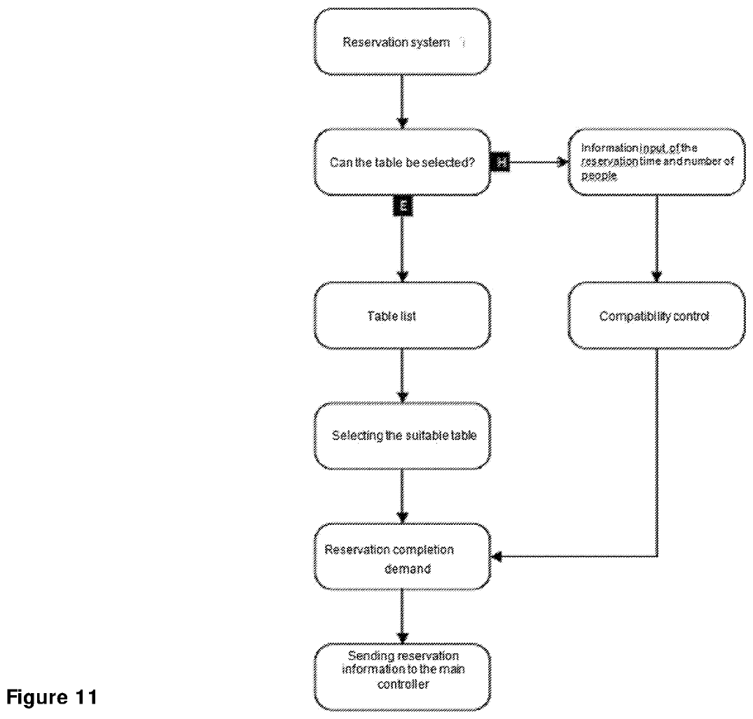

FIG. 11, shows the Restaurant module online reservation. The Restaurant module online reservation comprises the following;

The web interfaces can be used as a scripted theme, or as a customized module whose design can be changed directly by changing the JavaScript codes and by changing the style such as html, css etc.
A mobile application can be optionally added to the system for the module.
The customer can place a food order from the interface panel of the module.

The inventory logic (FIG. 5) is the same as e-commerce. As a menu can be additionally ordered (forming a menu by bringing together a plurality of inventories) the stock tables can be updated from the database and the module used as a shared scheme can be updated to the table database.
The payment system, adding to the shopping cart procedures function the same as the e-commerce module. (FIG. 6)
After the order has been taken, order transfer procedures are completed (FIG. 7).
The administrator can change the sales of the single product or menu sales whenever he/she desires for any time period he/she desires or can adjust the order processing hours during the day through the system.
If desired an online reservation system can be activated. The map of the place can be visually drawn through the main system. Informative fields can be created on the map. For example the smokers section, or table by the window can be defined. The map can also show the numbers of the tables and for how many people the tables are for. In accordance with this information the customer reservation, suitable table, date and personal information is entered (via the mobile application interface or through the web site) via the restaurant module.
If the administrator desires he/she can define the total number of tables only, without defining the tables themselves. If the system can operate this way, a table selection process is not carried out.
The online reservation system can be changed by the administrator. (Information that the table is available for reservation or not)
The tables regarding the restaurant tables are used with a shared table scheme both in the module database and company database.

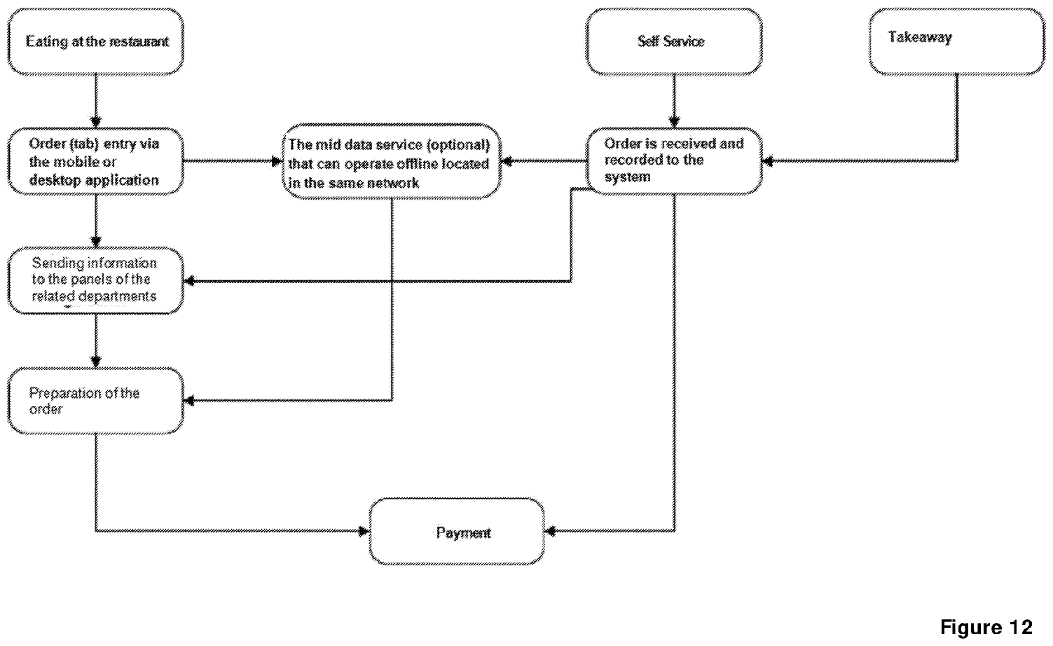

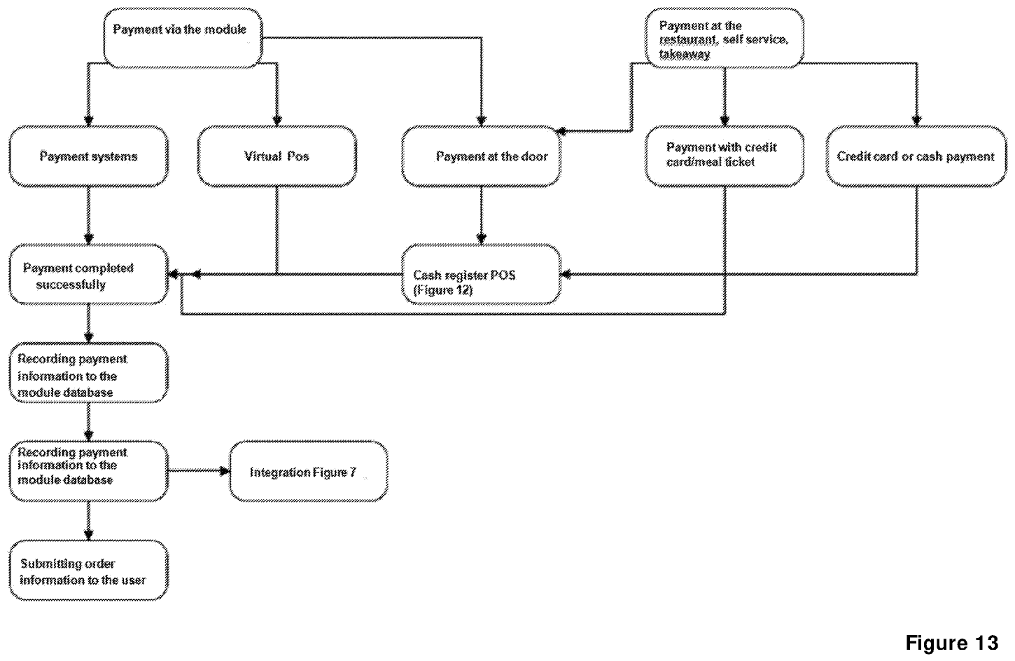

FIG. 12, shows the Restaurant module online ordering system (tab). An order can be placed in 3 different ways through the Restaurant module online ordering system (tab); These orders are,
6. Eating at the restaurant. A tab is created by selecting the table and order over the web application or personal mobile application for the customers that have arrived at the restaurant.
7. The product information is relayed on the panels of the related units in order for the order to be prepared (an automatic information slip can be printed out from a printer if desired).
   Or a shared computer or tablet computer that is open to the usage of the personnel in order to create a tab (order) can be used.
   The tab (order) information that is created is recorded to the main system.
   Following this the user can go onto the next step which is the payment step.
   The tab (order) system can be used offline. The data in the hardware device by means of the tabs that have been created via the mobile application and computer software are recorded. The data from the hardware is transferred to the company's database automatically when an internet connection is established.
8. If the order is self service, the customer arrives at the restaurant and places an order. A tab is created. When the order is completed a financial invoice is prepared. Following this the user can go onto the next step which is the payment step.
9. If the order is takeaway the order can be carried out in two steps. The first step is ordering through the restaurant module and the second step is ordering via phone. The restaurant module functions the same as in FIG. 6. The difference here is that the stock+menu system shall be used and if desired, a date range shall be determined manually and purchase order taking for the sales of products can be stopped.
10. Payment is transferred via the restaurant module, at the door upon delivery or at the restaurant (FIG. 13).

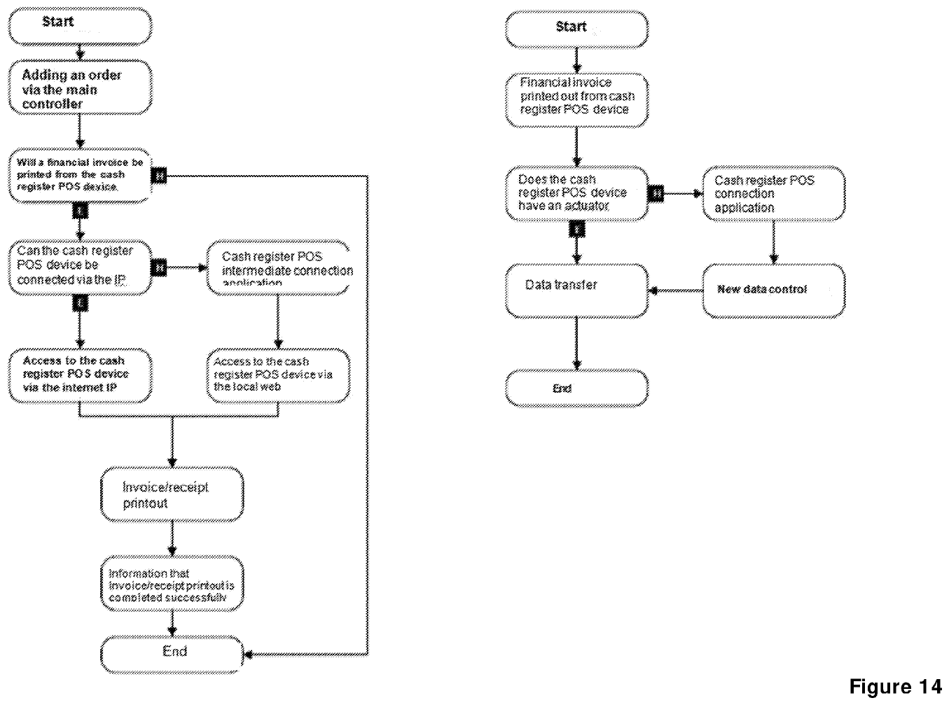

Payment systems are shown in FIG. 13. Payment systems;
Payment is carried out via the mobile application or web page through the restaurant module;
   Payment is made with virtual pos or by cash register pos device at the door via the negotiated banks by means of payment systems (such as pay pal payu etc.) through the module.
   The order information and payment information is recorded in the database of the module.
   The order information is submitted to the main system such that it operates synchronously (FIG. 7).
   If payment is made at the door the payment information is submitted to the main system such that it operates synchronously (FIG. 14).
   Information regarding the receipt of the order is submitted to the customer.
Payment is made at the door with cash register pos device or with meal tickets following self service purchasing or takeaway orders.
   If the payment has been made by cash register pos device (FIG. 14) or with meal the payment is recorded in the main system.

The cash register-pos device integration is shown in FIG. 14.; Integration of the cash register pos device; The cash register pos device integration is reciprocal. First of all the invoice or receipts that are billed from a cash register and the payment information (cash, credit card or meal ticket) thereof are transferred to a main system. The payment information of the invoices and receipted that were billed via the main system are sent to the cash register.

If the cash register cannot be matched online, it is connected to the main system via a desktop middleware located in a local network. In the case that connection is lost between the middleware and the main system the cash register can operate offline. When the internet connection is established, the transfer process will start.
The cash register-pos device integration process steps according to FIG. 14, basically comprises;
Starting the process,
Adding an order via the main controller interfaces,
Determining if a financial receipt can be printed out from the cash register pos device,
If a printout cannot be taken, the process is ended,
If a printout can be taken, it will be determined if the connection via the internet IP shall be accepted by the cash register pos device,
If the connection via the internet IP is not accepted by the cash register pos device;
   The next step of cash register pos connection application is taken,
   The cash register pos device is accessed via the local network,
   Printing out an invoice/receipt,
   Submitting information that the invoice/receipt printing has been completed successfully,
   Ending the process.
If the connection via the internet IP is accepted by the cash register pos device the following steps are taken;
   Accessing the cash register pos device via the internet IP,
   Printing out an invoice/receipt,
   Submitting information that the invoice/receipt printing has been completed successfully,
   Ending the process.
Starting the process,
Printing out a financial receipt via the cash register pos device,
Checking if the cash register pos device can be actuated or not,
If the cash register pos device does not have an actuator cash register pos device interconnection application step is taken,
New data is checked,
Moving on to the data transfer step and ending the process,
If the cash register device actuator is present, moving onto the data transfer step and ending the process.

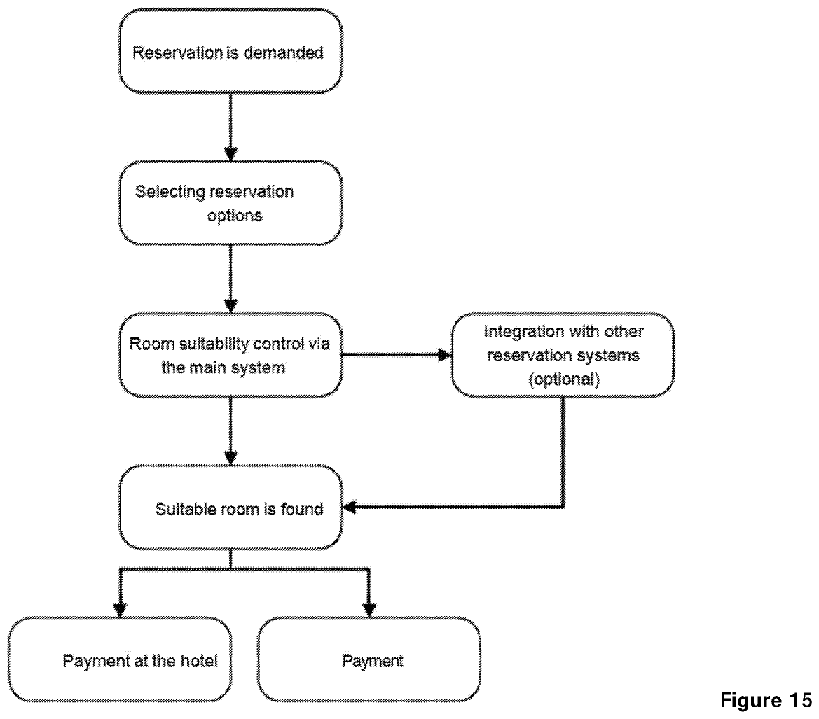

The hotel reservation system is shown in FIG. 15. The hotel reservation system enables reservation by selecting room type according to the room information provided through the module, the number of people that shall be staying, and the dates of check in and check out. After the total price is calculated the customer can move to the online payment page or the customer may prefer to pay at the hotel. If the customer chooses to pay at the hotel, some hotels may ask for pre-payment during reservation. The reservation system can be integrated with other reservation service providers such as booking.com or tripadvisor.com.

The hotel reservation system basically comprises the following process steps;
Making a reservation,
Selecting the reservation options,
Checking room suitability control through the main system,
Being integrated with other reservation systems (optional),
Finding a suitable room,
Completing the reservation,
Paying at the hotel or transacting pre-payment according to the preference of the hotel.

What is claimed is:

1. A managing pre-accounting, accounting and e-commerce system from a single panel, with an integrated interface and system, a modular structure, an user interface and/or a hardware that is configured to be directly accessed by the system, and system modules formed from an accounting and tax system, comprising module user interfaces, an inventory (stock) integration system, an e-commerce module product inventory query system, a shopping cart and payment system, examples of adding orders to a main system, a restaurant module online reservation, a restaurant module bill (check-order) system, payment systems, a cash register-pos device integration, a hotel reservation system, a connection to the tax system, a scanning and recognition of OCR invoices, financial receipts, checks and bills, and shared table schemes.

2. A managing pre-accounting, accounting and e-commerce system from a single panel, comprising an integrated interface and system, a modular structure, and system modules that comprise hardware that is configured to be accessed directly via a user interface or via a main system.

3. A managing pre-accounting, accounting and e-commerce system from a single panel, comprising an inventory (stock) integration system comprising the following process steps;
adding a new product from the single panel to an e-commerce system by a user,
asking the user if he/she wants to use a new stock card or an old stock card that is already present,
if a stock that is present is desired to be used, accessing an e-commerce database via a main system,
matching a same stock card from the e-commerce database of the main system, and defining and recording the new product as an e-commerce product in a registration section,
sending pictures of the new product by a controller of an e-commerce module,
if the pictures of the new product are successfully uploaded, a process is completed, and if a first error occurs, a rollback process is applied,
if the new stock card is desired to be added, creating a new record in a database of a company with a new stock information,
adding the new stock card that is created with the new record to a stock card table in a module database linked with the company in a common structure with a same identification number,
marking the new product as the e-commerce product in the e-commerce database of the e-commerce module,
if updating is completed, continuing the step of sending the pictures of the new product by the controller of the e-commerce module,
if a second error occurs, recalling latest procedures that are carried out from both the e-commerce database of the company and the e-commerce module,
notifying the user of the second error, and
showing a form of the new product form on the single panel for renewing an order, and previously entered values still remain on the single panel.

4. The managing pre-accounting, accounting and e-commerce system from the single panel according to claim 1, comprising an e-commerce inventory (stock) query system comprising the following process steps:
adding a product to the shopping cart via an e-commerce module by a user,
operating a stock tracking mechanism on a module controller,
sending a demand to a main system regarding stock information,
sending the demand regarding the stock information from the main system to a balance system,
sending the demand to a suitable web service according to a demand queue,
directly connecting the suitable web service to a database of a company and information regarding an inventory, and checking if a stock is suitable to be sold, and
creating a response message and returning a process to the module controller.

5. The managing pre-accounting, accounting and e-commerce system from the single panel according to claim 1, wherein, the shopping cart and payment system comprises the following process steps:
making a desire to purchase products in the shopping cart by a user,
carrying out a stock check for each of the products,
completing a shopping process by transferring a payment via applications such as paying at a door, a bank wire, a credit card, and pay pal,
recording a shopping information in a database of a module by a module controller,
the module controller submits an order information by operating synchronously (in a background) with a main system,
sending an information regarding a completion of the order information from platforms that the user has been using by the user,
if the shopping information is not transferred to the main system, making the module controller try to transfer the order information at 2, 4, 8, 16, 32, 64 seconds at a certain time cycle, and
if the order information is not transferred after a 20th time, submitting a transfer error to both an e-commerce manager and the main system.

6. The managing pre-accounting, accounting and e-commerce system from the single panel according to claim 1, wherein, in the shopping cart and payment system, if an order is not transferred after several trials preconfigured, submitting a transfer error both to an e-commerce manager and the main system.

7. The managing pre-accounting, accounting and e-commerce system from the single panel according to claim 1, wherein, the examples of adding the orders to the main system and comprising the following process steps;
demanding an additional order from a module,
checking module authorizations,
checking if a current card that belongs to a member that has given the additional order is present or not in a database of a company,
if the current card is not present, adding the company to the database of the main system, and keeping an integration information of an e-commerce system of a current customer shall be kept in a separate table,
after an order transfer is completed, submitting a signal to the module,
completing a cycle if an e-commerce module is at a transfer cycle,
marking a module database as “order has been transferred”,
checking the main system if the additional order is valid or not,
if the additional order is valid, adding the additional order to the database of the company,
if the additional order is received from the module, keeping a module order matching record together with the additional order added to a separate table in the company database,
if an invoice is to be created (the invoice can be created automatically according to a payment type, in module settings) creating a new invoice demand with an added order identification information,
checking the main system if the invoice is valid or not,
if the invoice is valid, adding the invoice to the database of the company,
checking if the new invoice demand is made through a cash register,
if the invoice is created through the cash register, the invoice that is added to the database of the company is matched with an identification information of the cash register,
if the invoice is requested, automatically printing the invoice by the cash register or taking a printout via the cash register, an invoice printer or a laser printer (printing the invoice by the laser printer varies from country to country) manually,
preparing the additional order to be shipped,
adding a new order through a main system module,
earring out a next step of checking user authorizations and order contents, and
making a new invoice addition demand from the cash register,
checking cash register authorizations and carrying out a step of checking the order contents of the invoice.

8. The managing pre-accounting, accounting and e-commerce system from the single panel according to claim 1, further comprises a restaurant module tab system (order system) comprising the following process steps;
creating a tab by selecting a table and order over a web application or a personal mobile application for customers that have arrived at a restaurant,
relaying a product information on panels of related units in order for an order to be prepared (an automatic information slip is printed out from a printer if desired),
to be able to use a shared computer or tablet computer that is open to an usage of a personnel in order to create the tab,
recording a tab information to related tables in the main system,
taking a next step of a payment,
recording data in a hardware device by means of the tab that has been created via the personal mobile application and a computer software,
transferring the data from the hardware device to a database of a company automatically when an internet connection is established,
if the order is self service, the customers arrives at the restaurant and place the order,
when the order is completed, preparing a financial invoice,
taking a next step of the payment,
optionally, taking the order by phone via the restaurant module tab system for take-away,
using a stock+menu system, and if desired, determining manually a date range and stopping a purchase order taking for sales of products, and
transferring the payment via the restaurant module tab system, at the door upon delivery or at the restaurant.

9. The managing pre-accounting, accounting and e-commerce system from the single panel according to claim 8, wherein, the restaurant module tab system (order system) comprises a tab system that operates offline.

10. A managing pre-accounting, accounting and e-commerce system from a single panel, comprising a payment system comprising the following process steps:
carrying out a payment via a mobile application or web page through a restaurant module;
paying with a virtual pos or by a cash register pos device at a door via negotiated banks by means of a payment system through the restaurant module,
recording an order information and an payment information in a database of the restaurant module,
submitting the order information to a main system synchronously,
if the payment is made at the door, submitting the payment information to the main system synchronously,
submitting information regarding a receipt of the order i-s to a customer,
making the payment at the door with the cash register pos device or with meal tickets following self service purchasing or takeaway orders, and
if the payment has been made by the cash register pos device or with the meal tickets, recording the payment in the main system.

11. The managing pre-accounting, accounting and e-commerce system from the single panel according to claim 1, further comprising a cash register pos device integration comprising the following process steps:
starting a process,
adding an order via main controller interfaces,
determining if a financial receipt is printed out from a cash register pos device,
if a printout is not taken, ending the process,
if a printout is taken, determining if a connection via an internet IP is accepted by the cash register pos device,
if the connection via the internet IP is not accepted by the cash register pos device;
taking a next step of a cash register pos connection application,
accessing the cash register pos device via a local network,
printing out an invoice/receipt,
submitting information that the printing of the invoice/receipt has been completed successfully, and
ending the process;
if the connection via the internet IP is accepted by the cash register pos device, take the following steps;
accessing the cash register pos device via the internet IP,
printing out an invoice/receipt,
submitting an information that the printing of the invoice/receipt has been completed successfully, and
ending the process;
starting the process,
printing out a financial receipt via the cash register pos device,
checking if the cash register pos device is actuated or not,
if the cash register pos device does not have an actuator, taking a cash register pos device interconnection application step,
checking new data,
moving on to a data transfer step and ending the process, and
if the actuator of the cash register device is present, moving onto the data transfer step and ending the process.

12. The managing pre-accounting, accounting and e-commerce system from the single panel according to claim 11, wherein, the cash register pos device integration has a reciprocal function.

13. The managing pre-accounting, accounting and e-commerce system from the single panel according to claim 11, wherein, the cash register pos device integration is configured to operate offline in case that a connection between to a middleware and a main system is lost.

14. The managing pre-accounting, accounting and e-commerce system from the single panel according to claim 1, further comprising the hotel reservation system comprising the following process steps;
making a reservation,
selecting reservation options,
checking a room suitability control through the main system,
capable of integrating with other reservation systems,
finding a suitable room,
completing the reservation, and
paying at a hotel or transacting a pre-payment according to a preference of the hotel.

15. The managing pre-accounting, accounting and e-commerce system from the single panel according to claim 1, further comprising a restaurant module online reservation system comprising the following process steps;
making a payment system and procedures of adding to a shopping cart play a same function an e-commerce module,
after an order has been taken, completing order transfer procedures,
changing sales of a single product or menu sales whenever desired for any time period desired by an administrator if,
adjusting order processing hours during a day regarding the single product or menu sales through the restaurant module online reservation system,
activating the restaurant module online reservation system if desired, visually drawing a map of a place through the main system, creating informative fields on the map, showing numbers of tables and for how many people the tables are for by the map if needed, entering a customer reservation, a suitable table, date and a personal information via a mobile application interface or through a web site via the restaurant module online reservation system,
if the administrator desires he/she only defines a total number of tables only, without defining the tables,
if the restaurant module online reservation system operates, without carrying out a table selection process,
changing the restaurant module online reservation system by the administrator if needed,
locating the tables regarding a reservation in a module database, and making a module controller and the main system directly access the module database, and
using the tables regarding the restaurant with a shared table scheme both in the module database and a company database.

16. The managing pre-accounting, accounting and e-commerce system from the single panel according to claim 15, wherein, the restaurant module online reservation system is configured such that an information regarding a suitability of the tables for the reservation is changed by the administrator.

17. The managing pre-accounting, accounting and e-commerce system from the single panel according to claim 15, wherein, in the restaurant module online reservation system web interfaces are configured such that the web interfaces are used as a scripted theme, or as a customized module, wherein a design of the scripted theme or the customized module is changed directly by changing JavaScript codes and by changing a style such as html, and css.

18. The managing pre-accounting, accounting and e-commerce system from the single panel according to claim 15, wherein, the restaurant module online reservation system is configured such that a mobile application can be integrated to the restaurant module online reservation system.

19. The managing pre-accounting, accounting and e-commerce system from the single panel according to claim 15, wherein, the restaurant module online reservation system is configured to comprises a module interface allowing a customer to place a food order.

20. The managing pre-accounting, accounting and e-commerce system from the single panel according to claim 15, wherein, the restaurant module online reservation system is configured that inventory list tables is accessed via both the module database and the shared table scheme of the company database by ordering an additional menu.

21. The managing pre-accounting, accounting and e-commerce system from the single panel according to claim 15, wherein, the restaurant module online reservation system is configured that ordering hours during the day is determined by the administrator.

22. The managing pre-accounting, accounting and e-commerce system from the single panel according to claim 1, wherein, the OCR invoice, the financial receipt, the check or the bill is scanned via an OCR receipt recognition module by using an image file from a web interface or a camera of a mobile device via a mobile application.

23. An OCR invoice, financial receipt and bill scanning and recognition tool performing the OCR receipt recognition module according to claim 22, wherein, an OCR invoice, financial receipt and bill scanning and recognition tool is configured to determine a total amount of receipts using an algorithm, receipt contents, a date, time and a receipt number, find an automatic current account record by means of a phone number, and have an OCR algorithm facilitating entering a receipt information desired to be transferred to a system of the OCR invoice, financial receipt and bill scanning and recognition tool.

24. An OCR invoice, financial receipt and bill scanning and recognition tool performing the OCR receipt recognition module according to claim 22, comprising an OCR having document scanning features comprising process steps of,
detecting a shift ratio by a system of the OCR invoice, financial receipt and bill scanning and recognition tool, in case that a total of the OCR invoice is printed a little beneath or above a total amount due to shifting of rows to another row in the OCR invoices,
the system includes a first recognition algorithm value, a second recognition algorithm value, a third recognition algorithm value and a fourth recognition algorithm value, wherein, the first recognition algorithm value distinguishes first fonts of texts having been written in an original invoice and second fonts of values having been printed with an invoice printer, the second recognition algorithm value calculates coordinates of scanned sections on a document, the third recognition algorithm value determines a table, if the document scanned has separation lines that separates the rows, or if the document is printed as a table, wherein a template recognition method is used to helps recognize and determine contents of the separation lines by analyzing written values in a first header column at a left side of the table or header columns and/or rows in a first line, and the fourth recognition algorithm value finds values by detecting headers having been pre-defined in the system.

25. An OCR invoice, and financial receipt and bill scanning and recognition tool performing the OCR receipt recognition module according to claim 22, wherein, following a scanning process, defined fields in a scanned document are transferred to new record form fields, and if a value is scanned incorrectly, a user corrects the value and the scanned document is recorded into the main system together with an image of the scanned document after confirmation.

26. The managing pre-accounting, accounting and e-commerce system from the single panel according to claim 1, comprising;
tables having a shared table scheme such as a stock card, an unit table, a VAT table, a variant table, a country, city, and a province table,
locating the tables operating in a shared structure both in a company database and a module database,
when a new record is added, editing or deleting an old record in the company database on tables used in the shared structure, automatically carrying out a same procedure in the module database, therefore maximizing preciseness,
performing batch record updating or single record updating on databases using identification information,
in case a data is not saved in a update process in the module database, retrieving processes carried out in the company database and reporting as errors,
changing numbers of the tables operating in the shared structure in accordance with suitability and development of the managing pre-accounting, accounting and e-commerce system, and
modifying the tables used in the shared structure to comprise an inventory card, the unit table, the VAT table, the variant table, a country, a province, a district and sub contents such as an ID number, a code, a name, a country, a vat rate, a unit, and a module product.

27. The managing pre-accounting, accounting and e-commerce system from the single panel according to claim 26, wherein, the shared structures is configured to eliminate a reference confusion between the company database and the module database.

28. The managing pre-accounting, accounting and e-commerce system from the single panel according to claim 1, further comprises the accounting and taxation system to prepare in the managing pre-accounting, accounting and e-commerce system and to submit from the managing pre-accounting, accounting and e-commerce system, a VAT, a VAT2, a VAT list to be uploaded, a VAT list to be downloaded, a withholding tax return, a form ba (statement of purchasing goods and services) and a form bs (statement of sales of goods and services), annual income statements, provisional tax returns (income), a corporation tax, provisional tax returns (corporation), sales invoices, and customs export declaration lists domestical and other documents needing to be submitted to a state or abroad.

29. The managing pre-accounting, accounting and e-commerce system from the single panel according to claim 1, further comprising the accounting and taxation system to submit various statements and declarations if required by a tax office in a related country supporting the accounting and taxation system.

30. The managing pre-accounting, accounting and e-commerce system from the single panel according to claim 1, further comprising the accounting and taxation system to obtain a accounts chart, a trial balance, an operating ledger, and an operating accounts summary.

31. The managing pre-accounting, accounting and e-commerce system from the single panel according to claim 1, further comprising the accounting and taxation system to either automatically or manually record receipts during an accounting process of pre-accounting receipts.

32. The managing pre-accounting, accounting and e-commerce system from the single panel according to claim 1, further comprising the accounting and taxation system to create either manually or automatically accounting codes for cards such as stocks, current accounts, and bank and cash accounts.

33. The managing pre-accounting, accounting and e-commerce system from the single panel according to claim 1, further comprising a hardware directly accessed by the main system using a user interface providing a communication with a invoice printer via an IP address, an internet explorer, a mobile application or a desktop application, with a receipt printer via the internet explorer, the mobile application or the desktop application, with a barcode reader and a cash register having a barcode reader via the internet explorer, the mobile application, a mobile camera, or the desktop application, or with a cash register pos device via the internet IP address, a middleware operating on a computer located on a network connected to the cash register with an ethernet card or with the middleware operating on the computer directly connected to the cash register.

34. The managing pre-accounting, accounting and e-commerce system from the single panel according to claim 1, comprising:
a modular structure operating on a web server having a controller, an HTML web interface of the modular structure for users and optional mobile applications.

35. The managing pre-accounting, accounting and e-commerce system from the single panel according to claim 1, further comprising a module structure updating itself via remote commands and update controls.

36. The managing pre-accounting, accounting and e-commerce system from the single panel according to claim 1, further comprising a modular structure comprising mobile applications directly communicating with a module service through a module.

37. The managing pre-accounting, accounting and e-commerce system from the single panel according to claim 1, further comprising a modular structure comprising mobile applications communicating with the main system.

38. The managing pre-accounting, accounting and e-commerce system from the single panel according to claim 1, further comprising a modular structure comprising a module controller configured to perform payment procedures for an order given through a module.

39. The managing pre-accounting, accounting and e-commerce system from the single panel according to claim 1, further comprising a modular structure using web services in order to access modules in the main system.

40. The managing pre-accounting, accounting and e-commerce system from the single panel according to claim 1, further comprising a modular structure configured for a company to have a plurality of modules.

41. The managing pre-accounting, accounting and e-commerce system from the single panel according to claim 1, further comprising an integrated interface and system serving to control all modules, integrations and crucial data connected to the managing pre-accounting, accounting and e-commerce system.

42. The managing pre-accounting, accounting and e-commerce system from the single panel according to claim 1, further comprising an integrated interface and system comprising an Html web interface, a mobile application, desktop applications configured to carry out transactions between a user and a service.

43. The managing pre-accounting, accounting and e-commerce system from the single panel according to claim 1, further comprising an integrated interface and system comprising the main system configured to directly access a database of modules and updating for tables having a shared scheme with the modules.

44. The managing pre-accounting, accounting and e-commerce system from the single panel according to claim 1, further comprising the following steps:
forming a declaration by an accounting department,
providing a reliable connection to a tax system,
submitting the declaration, and
creating a report according to a declaration type.
